(19) United States
(12) Patent Application Publication
(10) Pub. No.: US 2004/0154281 A1
(43) Pub. Date: Aug. 12, 2004

(54) Concept design of heat engines combustion chamber configuration in the earth atmosphere and airless conditions

(76) Inventor: Feodor Koudinov, Mississauga (CA)

Correspondence Address: FEODOR KOUDINOV, APT. #205, 3355 PONYTRAIL DR, MISSISSAUGA, ON, L4X 1V7, CA

(21) Appl. No.: 10/361,185

(22) Filed: Feb. 10, 2003

(51) Int. Cl. F02C 3/14

(52) U.S. Cl. 60/39.35

(57) ABSTRACT

The new concept design proposed by Feodor Koudinov of the configuration of heat engines combustion chamber in the earth atmosphere and airless conditions with intended use in:

gas generators,

ground transportation of various application,

sea and river vessels, submarines,

propeller flying apparatus,

air cushion vessels,

railway transportation,

any kind of auxiliary equipment,

electrical power units,

propulsion engines.

The combustion chamber new concept design presents a part in widely used thermal or/and chemical working pressure generating engines. As there are known drawbacks in the above engines (among the worst are: heat tension, limited time of operation, mechanical tension on combustion chamber created by pressure, need to cool down the combustion chamber elements, no re-use of the propulsion system elements, complicated and expensive manufacturing) the proposed new concept design of the combustion chamber eliminates and/or drastically reduces the above listed shortcomings.

### DESCRIPTION

The proposed new concept design of the combustion chamber is a combustion chamber body rotating against its axis. A thrust force is being produced along the combustion chamber axial direction. Driven by the centrifugal force one of the fuel components in solid/powder or liquid state is forced to evenly spread on the inner surface of the combustion chamber. This creates a protective layer consisting of that fuel component. In the process of the first fuel component burning with the second fuel component, new quantities of the first fuel component replenish the combustion chamber protective surface layer.

The replenishing speeds allow controlling the level of the fuel component of the protective layer. The rotation speed increase or reduce the protective layer pressure on the inner surface of the combustion chamber.

The proposed combustion chamber is compatible with any kind of expanding nozzle (Laval) and nozzle with a central body. Combustion chamber can be rotated as well as self-rotate with blades installed inside the combustion chamber. The combustion chamber in this particular case becomes a source of rotation. Exhaust airflow spinning blades may combine with a compressor in gas turbine engines. The inner combustion chamber blades are cooled down by inner surface wash through.

To increase the flaming process performance output the warmed up fuel circulates and mixes with the tank fuel.

By its design the combustion chamber eliminates the wash through procedure. The combustion chamber can be made homogeneous with thicker walls resulting in stronger and more reliable design.

One combustion chamber may be installed inside another combustion chamber. The inner combustion chamber will receive the excessive amount of a component and this ensures the complete fuel burning in the external combustion chamber.

The volume of the second component input controls the thrust force of the engine. The combustion chamber may serve as a solid/powder state fuel component and be mixed with other fuel component in a liquid state.

By increase of the combustion chamber diameter a Koriolis centrifugal effect is created and installation of concentric blades into the combustion chamber it turns into a centrifugal turbine.

### BRIEF DESCRIPTION OF THE DRAWINGS

FIG. 1 is a schematic illustration of the invention.

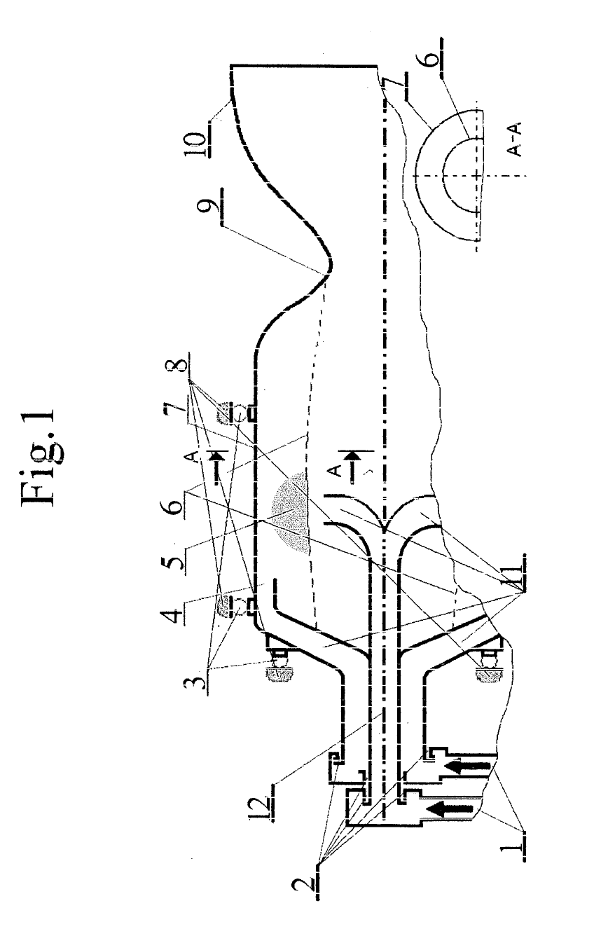

1. Fuel components feed

2. Sealing elements

3. Rotation elements

4. Fuel component inflow into combustion chamber (here: cooling element)

5. Mixing area

6. Cooling component level

7. Combustion chamber fire wall

8. Vehicle/craft body

9. Critical throat section

10. Laval nuzzle

11. Fuel components inflow into combustion chamber

12. Combustion chamber rotation axle

What is claimed is:

1. The rotation of the combustion chamber body around one of its axis resulting in creation of dynamic force inside its body and fixation via the dynamic force of one of the fuel components on the combustion chamber inner surface.
